(19) United States
(12) Patent Application Publication
(10) Pub. No.: US 2003/0212637 A1
(43) Pub. Date: Nov. 13, 2003

(54) Automated method and system for enrollment

(76) Inventor: Michael B. Turner, Hurst, TX (US)

Correspondence Address: Philip G. Meyers, Philip G. Meyers Intellectual Property Law, P.C., Suite 302, 1009 Long Prairie Road, Flower Mound, TX, 75022, US

(21) Appl. No.: 10/142,351

(22) Filed: May 9, 2002

(51) Int. Cl. G06F 17/60

(52) U.S. Cl. 705/45

(57) ABSTRACT

A method for customer enrollment at an automated terminal such as an ATM includes, as consecutive steps, receiving input of an identifier from a prospective customer at the terminal, using the identifier to query a database containing consumer credit information, if the identifier is associated with a unique record in the database then retrieving items of information associated with the identifier from the database, posing one or more questions using the information from the database as the answers to the questions, receiving from an input device of the automated terminal a response to each question from the customer, determining if each response given by the customer matches the answers from the information from the database, and if a predetermined minimum number of matching answers are given, approving the customer for a transaction (such as cashing a check) to be conducted at the automated terminal. The invention further provides a system for carrying out such a method, which systems includes an automated terminal have a keyboard that can receive input of the identifier from a prospective customer at the terminal and a screen for displaying information to the customer, together means such as software for effecting the subsequent steps of the method.

### TECHNICAL FIELD

The present invention relates to the field of automated account creation or program enrollment, in particular to a method and apparatus for establishing a new account without human intervention or confirmation.

### BACKGROUND OF THE INVENTION

Many financial services are provided through automated teller machines (ATM's). These machines are in common use, but cannot be used in the same manner as a computer because they lack an alphanumeric keyboard. A typical ATM machine includes a numeric keypad (for entering transaction amounts) and a series of keys (eight) for selecting an item from a menu presented on the associated screen. ATM's are common used by banks for simple transactions such as deposits and withdrawals, determining account balances, and transfers.

With the advent of the Internet, it has become possible to establish new accounts with a financial service provider online, rather than in person or by telephone. However, a sizable percentage of persons wishing to open new accounts or enroll in programs lack Internet access or are not inclined to use it. Similarly, a substantial number of people do not use banks and must find alternate routes, such as check cashing services, for cashing checks. Retail check cashing outlets for this purpose are widespread.

Recently it has been proposed to use ATM's for automated check cashing. This permits a check cashing service to be offered at lower fees than would be possible at a retail outlet. See for example, Hyde, Jr., U.S. Pat. No. 6,038,553, which describes an automated self service method of and system for cashing checks including a check cashing database that contains customer records for registered customers, Shah U.S. Pat. No. 6,129,273 (Method and apparatus for an automated, computer approved, check cashing system), and Stinson, et al. U.S. Pat. No. 6,045,039 (Cardless automated teller transactions.) However, for a new customer wishing to open a check cashing or bank account, it is still necessary to register the accounts in one of the known ways (by phone, online, or in person) before the ATM can be used. Generally an ATM card with PIN must be issued before the consumer can use the ATM with the newly created account. The cardless system suggested by U.S. Pat. No. 6,045,039 uses stored biometric information instead of a card.

The present invention addresses the need for a way of using an ATM machine, even without an ATM card or similar means in hand, to establish a new account with the financial institution controlling the machine and then cashing a check using the new account, if desired.

### SUMMARY OF THE INVENTION

In a first aspect the invention, a method for customer enrollment at an automated terminal such as an ATM includes as consecutive steps:

(a) receiving input of an identifier such as a phone number from a prospective customer at the terminal;

(b) using the identifier to query a database containing consumer credit information;

(c) if the identifier is associated with a unique record in the database, retrieving items of information associated with the identifier from the database;

(d) posing one or more questions using the information from the database as the answers to the questions;

(e) receiving from an input device of the automated terminal a response to each question from the customer;

(f) determining if each response given by the customer matches the answers from the information from the database; and

(g) if a predetermined minimum number of matching answers are given, approving the customer for a transaction (such as cashing a check) to be conducted at the automated terminal. The invention further provides a system for carrying out such a method, which system includes an automated terminal having a keyboard that can receive input of the identifier from a prospective customer at the terminal and a screen for displaying information to the customer, together with suitable means (typically software) for effecting the subsequent steps of the method. The keyboard of the terminal is preferably used as the input device and the screen is used to display answers to challenge response questions, as described further in the detailed description that follows.

### BRIEF DESCRIPTION OF THE DRAWING

For a more complete understanding of the features and advantages of the present invention, reference is now made to the detailed description of the invention along with the accompanying drawings, in which:

FIG. 1 is a flow chart of a method of enrollment according to the invention; and

FIG. 2 is a schematic diagram of a system for implementing the method of the invention.

### DETAILED DESCRIPTION

The invention provides a process by which new customers are enrolled and new accounts are established on ATM's, without the intervention of a human operator at a call center. Companies presently use a variety of different methods to enroll and verify or validate consumers wishing to establish accounts. The process of the invention uses an automated enrollment procedure that allows the customer to select the correct answer to one or more questions that only that individual consumer would know.

Such questions as “What is your mother's maiden name?” are currently used to confirm identity under certain circumstances, such as when an account password has been lost. These are referred to as challenge-response questions. The typical consumer gives this kind of information repeatedly to service providers over time, and the information is collected in databases maintained by credit bureaus such as Experian, Equifax, and other credit reporting agencies. Accordingly, a service provider with online access to a credit bureau database can pose a series of challenge response questions to verify the identity of a consumer wishing to open a new account. This can be done easily over the telephone or online using a computer, wherein the applicant can type in the response. ATM's, which lack a standard keyboard for entering text information, have not been used for this purpose. According to the invention, this limitation is overcome by presenting the challenge-response question in a form which does not require a full text keyboard, for example, multiple choice. The applicant is asked to select the correct answer from among several choices. A more lengthy series of yes or no questions could also be used.

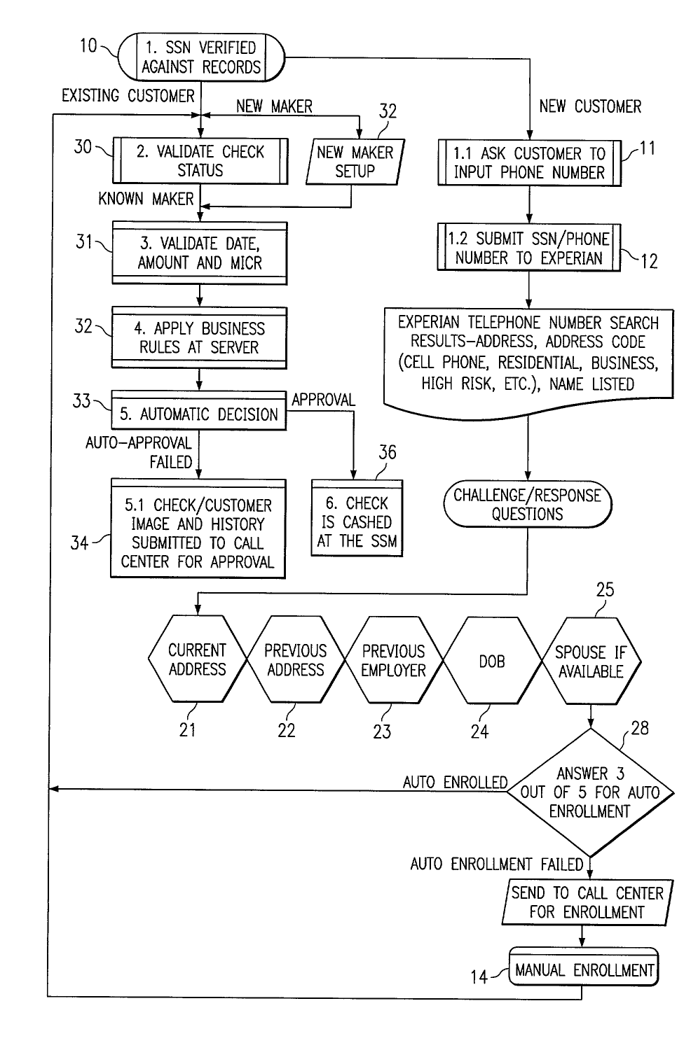

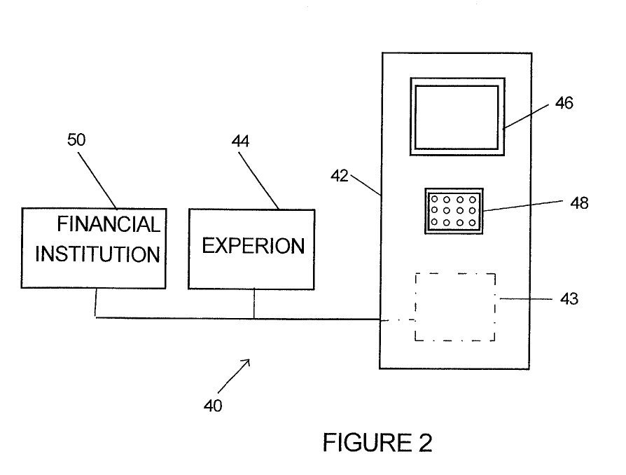

The process is implemented using software that carries out the steps shown in FIG. 1 and the system 40 shown in FIG. 2. Initially, in a preliminary step conducted at an ATM 42, the applicant feeds a check to be cashed into the ATM machine 42 and enters a social security number (SSN) which is used as an account number. If the number is associated with an existing customer (decision step 10), the system 40 proceeds directly with the check cashing process as described below. If the SSN is not that of an existing customer, the system attempts to automatically enroll the customer by asking the customer's home telephone number in a subsequent data entry step 11. In step 12, a control computer 43 of system 40 then sends this data to a credit information agency 44 or other database of equivalent information and awaits a response. The response based on telephone number search results includes the consumer's name, street address, date of birth, spouse's name, work address, and may include former addresses and former employers. If, for some reason, the applicant is unknown to the credit information agency or a search error is generated, the process is halted and the information is submitted to a call center 14 for approval/disapproval of enrollment. The call center substitutes human review for the automated process, but would not typically allow the customer to talk to the reviewer directly unless a telephone/speakerphone is provided at the ATM for that purpose.

Assuming the applicant is identified, the response information is used to prepare a challenge response question, preferably a series of two or more such questions. The system, for example, selects the applicant's current address, previous address, previous employer, and spouses name. These are each presented in a series of challenge response questions 21-25. The correct information may be present at a random location in one of the eight areas of a screen 46 associated with two rows of select buttons on either side of the screen, at the same time as similar incorrect entries, or may be a numerical list from which an entry is chosen using a numeric keypad 48. The incorrect entries can be selected from databases of similar information compiled by the entity owning or running the system, or from additional random queries made from the credit information agency for different persons. The following is an example of a typical series of screens and questions following entry of the SSN, wherein C-F represent the challenge response questions:

A.

Is the following information correct?

JOHN DOE-SMITH
8113 SUMMIT PEAK
LEWISVILLE
TX
75077

1. Yes
2. No

B.

Please enter your current phone number including area code and press OK.

972-555-5549

C.

Please choose one of your previous address from the list below.

| | |
|---|---|
| 1. | 226 ELMWOOD |
| 2. | 2213 N CALHOUN |
| 3. | 5324 LANDINO ST |
| 4. | 4113 CURZON |
| 5. | 7138 MAPLE PARK |
| 6. | 1960 W. TARRANT RD #304 |
| 7. | 7360 PARKRIDGE BLVD APT 442 |
| 8. | NONE OF THE ABOVE |

D.

Please choose one of your previous address from the list below.

| | |
|---|---|
| 1. | 8701 CALMONT 121 |
| 2. | 3862 LEBOW ST |
| 3. | 3427 W ROCHELLE 2091 |
| 4. | 2720 PUTMAN |
| 5. | 1300 W LOVERS LANE |
| 6. | 44S CLEARFIELD |
| 7. | 3517 N STORY RD APT 213 |
| 8. | 421 W LAWSON RD LOT 51 |

E.

Please select your month of birth from the list below.

| | |
|---|---|
| 1. | JANUARY |
| 2. | DECEMBER |
| 3. | AUGUST |
| 4. | FEBRUARY |
| 5. | MAY |
| 6. | SEPTEMBER |
| 7. | JUNE |
| 8. | APRIL |

F.

Please choose your spouse's first initial.

| | |
|---|---|
| 1. | U |
| 2. | X |
| 3. | A |
| 4. | D |
| 5. | G |
| 6. | J |
| 7. | L |
| 8. | M |

G.

Please choose one of your previous employer from the list below.

| | |
|---|---|
| 1. | QUAKER |
| 2. | OAK LAWN METHODIST CHURCH |
| 3. | HOME SHOPPING CLUB |
| 4. | TARRANT PRINTING |
| 5. | ROBERTSON TELEMARKETING |
| 6. | ERNEST YOUNG REIMB |
| 7. | CSWL |
| 8. | JOHN OR SHERRY CHOATE |

According to a preferred aspect of the invention, a margin of error is provided in the challenge response questions. The applicant is permitted to make one or more incorrect responses if a majority of the responses are correct (in this example 3 out of 5). In decision 28, the system aborts the process and refers the applicant to the call center if a failing score resulted from the questions, and continues with the enrollment process if the score was passing. Optionally, once the number of correct responses reaches the minimum, the system moves to the next step and skips the remaining questions. If a passing score was obtained, the credit information is used to establish a new account for the customer which is transmitted to the entity 50 operating the ATM machine, such as a financial institution, and process then returns to the first step 30 of the check cashing process, as for an existing customer.

The check cashing sequence may be any of the ones known in the art as exemplified by the foregoing patents. According to one such sequence illustrated herein, the image of the check is analyzed with OCR or bar code scanning software (if bar codes are provided) to identify the maker of the check. Once the maker name has been identified, a check is made of a database of known, approved makers. If a match is found, the system proceeds with validation step 31. If not, a database record for a new maker is prepared (step 32). The date, amount and MICR (magnetic ink character recognition) are then validated in step 31, and the server then applies business rules (step 32) selected by the financial institution to determine whether the check should be cashed. These rules are comparable to those in use now for check cashing by other means, such as in person at a retail outlet. The rules take into account, for example, the check cashing history of the maker, the amount of the check, the check cashing history of the presenter. An automatic approval decision is then made (step 33). If the check is auto-approved, the check is retained by the ATM and cash is dispensed, less the applicable check cashing fee. If auto-approval fails, the check image and image of the customer (such as taken by a digital camera mounted on the ATM) are sent to call center 14 for approval/disapproval (step 34). If the call center 14 disapproves either the new enrollment or the check presented, then the process is aborted and no cash is dispensed. Otherwise, the process concludes with dispensing cash at the ATM at step 36. The system may thereafter generate a summary of the transaction and mail it to the customer's home address to verify that the one cashing the check was the person at that address.

By eliminating the need for a human to differentiate correct answers to the questions, the method of the invention reduces cost for new customer sign-up. Furthermore, the time for new customer acquisition decreases because there is no queue of customers at a call center waiting to be enrolled. Enrollment is controlled by the customer, eliminating wait time.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. The method could, for example, be offered in an online format with either multiple choice or fill in the blank style challenge response questions. Similarly, the process of enrollment could be conducted independently of cashing a check, and could be used to dispense items other than or in addition to cash; for example, if the ATM dispenses tickets, stamps, phone cards or the like, such items could be purchased by check without human intervention, with the possible additional requirement of a change machine to handle the difference between the amount of the check and the item to be purchased, if any. It is, therefore, intended that the appended claims encompass any such modifications or embodiments.

1. A method for customer enrollment at an automated terminal, comprising:
(a) receiving input of an identifier from a prospective customer at the terminal;
(b) using the identifier to query a database containing consumer credit information;
(c) if the identifier is associated with a unique record in the database, retrieving items of information associated with the identifier from the database;
(d) posing one or more questions using the information from the database as the answers to the questions;
(e) receiving from an input device of the automated terminal a response to each question from the customer;
(f) determining if each response given by the customer matches the answers from the information from the database; and
(g) if a predetermined minimum number of matching answers are given, approving the customer for a transaction to be conducted at the automated terminal.

2. The method of claim 1, wherein the automated terminal is an automatic teller machine.

3. The method of claim 2, wherein the transaction is cashing a check.

4. The method of claim 3, wherein the questions are multiple choice questions wherein the correct answer is displayed on a screen along with two or more incorrect answers.

5. The method of claim 4, wherein the input device comprises buttons positioned to correspond to each of the possible answers displayed on the screen.

6. The method of claim 5, wherein steps (d) and (e) are repeated at least five times to pose at least five questions and obtain a corresponding number of consumer responses, and the predetermined number in step (g) comprises at least a majority of the questions posed.

7. The method of claim 6, wherein the automatic teller machine lacks means for inputting characters of the alphabet.

8. A system for customer enrollment, comprising:
an automated terminal have a keyboard that can receive input of an identifier from a prospective customer at the terminal and a screen for displaying information to the customer;
means for using the identifier to query a database containing consumer credit information;
means for retrieving items of information associated with the identifier from the database if the identifier is associated with a unique record in the database;
means for posing one or more questions on the screen using the information from the database as the answers to the questions;
means for receiving from the keyboard a response to each question from the customer;
means for determining if each response given by the customer matches the answers from the information from the database; and
means for approving the customer for a transaction to be conducted at the automated terminal a predetermined minimum number of matching answers are given.

9. The system of claim 8, wherein the automated terminal is an automatic teller machine, and the transaction is cashing a check.

10. The system of claim 9, wherein the keyboard includes a number of option selection keys located proximate the screen, the questions are multiple choice questions wherein the correct answer is displayed on a screen along with two or more incorrect answers, and the customer selects one of the answers displayed by pressing one of the option buttons.

11. The system of claim 10, wherein the automatic teller machine lacks means for inputting characters of the alphabet.
